(19) United States
(12) Patent Application Publication
(10) Pub. No.: US 2015/0336311 A1
(43) Pub. Date: Nov. 26, 2015

(54) METHOD AND APPARATUS FOR OVERMOLDING FRAGILE HOLLOW ARTICLE

(71) Applicant: The Procter & Gamble Company, Cincinnati, OH (US)

(72) Inventors: Matthew Lloyd NEWMAN, Cincinnati, OH (US); Andreas LARSCHEID, Bad Soden (DE); John Kit CARSON, Liberty Township, OH (US)

(21) Appl. No.: 14/577,393

(22) Filed: Dec. 19, 2014

Related U.S. Application Data
(60) Provisional application No. 61/918,438, filed on Dec. 19, 2013.

(51) Int. Cl. B29C 45/14

(52) U.S. Cl. CPC B29C 45/14811; B29K 2101/12

(57) ABSTRACT

A method and apparatus for of overmolding a fragile hollow item with a plastic material. The process comprises providing the fragile hollow item collapsible under a pressure of about 25 MPa and greater and at least partially overmolding the fragile hollow item with the thermoplastic material while maintaining a substantially constant melt pressure of less than about 25 MPa. An apparatus for said process comprises at least two mold parts forming therebetween a mold cavity for receiving the fragile hollow item, an injection device for injecting the thermoplastic material into the mold cavity and over the hollow item, and a pressure-control mechanism for monitoring a melt pressure of the thermoplastic material and adjusting an injection pressure according to a pressure-dominated algorithm based on the melt pressure, wherein the pressure-control mechanism comprises at least one high-frequency pressure sensor located upstream of the mold cavity's front end.

### TECHNICAL FIELD

The present disclosure relates to methods of forming injection-molded articles, and more particularly to methods of forming injection-molded articles by overmolding a hollow fragile component thereof.

### BACKGROUND

Multiple consumer goods are being made using a number of molding methods, e.g., injection molding and blow molding. Such articles may be formed using multiple techniques if, e.g., different materials are used or different functions are required of the final injection molded article. A plastic body of a toothbrush, e.g., may be made using processes involving injection molding, blow molding, and overmold injection-molding methods. In some instances, the final injection-molded article may be beneficially formed by overmolding a component, which can be pre-manufactured.

Overmolding a component comprising a hollow structure, however, presents additional challenges because such a hollow structure would inherently have a lower tolerance for withstanding conventional injection-molding pressures. In addition, such a hollow, relatively fragile structure may have certain properties related, e.g., to temperature, pressure, or shear sensitivity, that may need to be accommodated during an overmolding operation. At the same time, typical high-output injection-molding systems (e.g., class 101 and class 30 systems), inject plastic material into the mold cavity at melt pressures of 15,000 psi or higher. Manufacturers of shear-thinning plastic material teach injection-molding operators to inject the plastic material into the mold cavities above a minimum melt pressure. Polypropylene resin, e.g., is typically processed at pressures greater than 6,000 psi, the recommended range from the polypropylene-resin manufacturers being typically from greater than 6,000 psi to about 15,000 psi. Press manufacturers and processing engineers usually recommend processing shear-thinning polymers at the top end of the range, or significantly higher, to achieve maximum potential shear thinning, which is typically greater than 15,000 psi, to extract maximum thinning and better flow properties from the plastic material. Shear thinning thermoplastic polymers generally are processed in the range of over 6,000 psi to about 30,000 psi.

It is apparent that a fragile hollow thin-walled item, which is not entirely supported from inside by a core element that can otherwise provide support for the walls of the hollow item and resistance to the outside melt pressure, will likely not be able to tolerate such high melt pressures. The present disclosure, therefore, is directed to a method of overmolding a hollow fragile article that would not otherwise withstand conventional injection-molding pressures.

### SUMMARY

In one aspect the disclosure is directed to a method of overmolding a fragile hollow item with a plastic material. The hollow item may comprise a variety of articles, including, without limitation, a component or a sub-component for a personal-care article, e.g., selected from the group consisting of a toothbrush, a razor, a hairbrush, and a topical applicator. The hollow fragile item may comprise a material selected from the group consisting of plastic, glass, thin-walled metal, foil, ceramic, cardboard, cellulose, wood, carbon-fiber composite, and any combination thereof.

The method comprises providing the hollow fragile item comprising relatively thin walls and collapsible under a pressure of about 25 MPa (3,640 psi) and greater; placing the follow fragile item in a first mold, wherein from about 5% to about 95% of an overall area of the walls of the hollow fragile item is not supported from inside the hollow fragile article; providing a first thermoplastic material; heating the first thermoplastic material to a first predetermined temperature thereby causing the first thermoplastic material to be in a flowable state; at least partially overmolding the hollow fragile item with the first thermoplastic material in a first mold while maintaining a substantially constant melt pressure of the first thermoplastic material of less than about 25 MPa, thereby preventing the relatively thin walls of the hollow fragile item from collapsing under the melt pressure; and causing the first thermoplastic material to solidify over and in contact with the walls of the hollow fragile item, thereby forming a first overmolded article. The method may further comprise reducing the temperature of the first thermoplastic material to cause the first thermoplastic material to substantially solidify.

In one embodiment, the process comprises providing the fragile hollow item collapsible under a pressure of from about 10 MPa to about 25 MPa, and maintaining a substantially constant melt pressure of the first thermoplastic material lower than about 10 MPa. In another embodiment, the process comprises providing the fragile hollow item collapsible under a pressure of from about 5 MPa to about 10 MPa, and maintaining a substantially constant melt pressure of the first thermoplastic material lower than about 5 MPa. In still another embodiment, the process comprises providing the fragile hollow item collapsible under a pressure of from about 1 MPa to about 5 MPa, and maintaining a substantially constant melt pressure of the first thermoplastic material lower than about 1 MPa.

Maintaining a substantially constant melt pressure of the first thermoplastic material may include repeatedly determining the melt pressure of the first thermoplastic material at an injection nozzle upstream of the mold. This can be done by using at least one sensor in operative communication with at least one controller, wherein the at least one sensor repeatedly sends a signal to the at least one controller, the signal indicating the melt pressure of the first thermoplastic material in the mold.

In one embodiment, the first thermoplastic material may have a melt-flow index of from about 0.1 g/10 min to about 500 g/10 min. In another embodiment, the first thermoplastic material may have a melt-flow index of from about 1 g/10 min to about 100 g/10 min. In further embodiments, the first thermoplastic material may have a maximum melt pressure in the first mold cavity from about 1 MPa to about 25 MPa, or from about 5 MPa to about 10 MPa, or from about 1 MPa to about 5 MPa, or up to 1 MPa. In still further embodiment, a maximum melt pressure of the first thermoplastic material inside the first mold cavity can be within about 30% of a minimum melt pressure of the first thermoplastic material inside the first mold.

In one embodiment, the predetermined first temperature of the first thermoplastic material can be at least about 30 degrees Celsius lower than a heat-deflection temperature of the hollow fragile item. As used herein, the term “heat-deflection temperature” (also known as “heat-distortion temperature”) is the temperature at which a polymer or plastic form deforms under a specified load.

In a further embodiment, the hollow fragile item may comprise a temperature-sensitive component, such that the hollow fragile item experiences plastic or elastic deformation at the hollow item's deformation temperature and wherein the first predetermined temperature is lower than the hollow item's deformation temperature. As used herein, the term “elastic deformation” refers to a reversible deformation, wherein once the deformation forces are no longer applied, the object subject of deformation returns to its original shape. The term “plastic deformation” refers to irreversible deformation. However, an object experiencing plastic deformation first undergoes elastic deformation, which is reversible; hence the object will at least partially return to its original shape.

In one embodiment, the hollow fragile item may comprise a shear-pressure-sensitive component, such that the hollow fragile item experiences deformation at an upper shear-pressure limit. Then, the first thermoplastic material can be injected in the mold at a melt pressure that produces, inside the first mold between the first thermoplastic material and the hollow fragile item, a shear pressure that is lower than the upper shear pressure limit.

In another embodiment, the hollow fragile item may comprise an injection-pressure-sensitive component, such that the hollow fragile item experiences deformation at maximum injection pressure. Then the melt pressure of the first thermoplastic material entering the first mold can be lower than the maximum injection pressure.

The process may further comprise overmolding the fragile item with another thermoplastic material or other thermoplastic materials. This would include, e.g., providing a second thermoplastic material; heating the second thermoplastic material to a second predetermined temperature thereby causing the second thermoplastic material to be in a flowable state; at least partially overmolding the first overmolded article with the second thermoplastic material in a second mold; and causing the second thermoplastic material to solidify over and in contact with at least one of the solidified first thermoplastic material and the walls of the hollow fragile item.

The method may further comprise inflating the hollow fragile item by injecting an injection fluid into a body of the hollow fragile item during the overmolding operation. This will increase an internal pressure on walls of the hollow fragile item from inside. One non-limiting example of the fluid suitable for inflating the hollow item from inside is air. The fluid can be beneficially injected into the hollow item's body to substantially equalize the internal pressure and the melt pressure created by the first thermoplastic material.

In another aspect, the disclosure is directed to an apparatus for overmolding a hollow fragile item with a plastic material. The apparatus comprises at least a first mold part and a second mold part forming therebetween a first mold cavity structured and configured to receive the hollow fragile item therein so that there is a space in the mold cavity between the hollow item secured therein and the at least one of the first and second mold parts. The first mold cavity has a volume, a front end, and a rear end opposite to the front end; an injection device comprising at least a first injection nozzle for injecting a molten thermoplastic material into the mold cavity and over the hollow fragile item; and a pressure-control mechanism for monitoring a melt pressure of the thermoplastic material and adjusting an injection pressure imparted by the injection device on the thermoplastic material according to a pressure-dominated algorithm. The pressure-control mechanism comprises at least a first high-frequency pressure sensor located upstream of the front end of the first mold cavity. The pressure-dominated algorithm is based on the melt pressure of the thermoplastic material.

The pressure-control mechanism may further comprise at least a second high-frequency pressure sensor located at a last location to be filled in the mold cavity, a controller in operative communication with the first high-frequency pressure sensor and the second high-frequency pressure sensor for computing a required injection pressure, and an injection-control unit in operative communication with the controller for providing the required pressure while the first thermoplastic material is being injected into the first mold cavity.

In one embodiment, each of the at least a first high-frequency pressure sensor and a second high-frequency pressure sensor comprises a piezoelectric transducer structured to detect from 100 melt-pressure measurements per second to 500 melt-pressure measurements per second.

### BRIEF DESCRIPTION OF THE DRAWINGS

The embodiments set forth in the drawings are illustrative in nature and not intended to limit the subject matter defined by the claims. The following detailed description of the illustrative embodiments can be understood when read in conjunction with the following drawings, where like structure is indicated with like reference numerals and in which:

FIG. 1 schematically illustrates an embodiment of a hollow fragile item secured in a mold cavity, the item to be overmolded with a thermoplastic material.

FIG. 1A is a schematic cross-sectional view of another embodiment of a hollow fragile item partially overmolded with a thermoplastic material.

FIG. 2 schematically illustrates an example of stress-strain curves as a function of temperature for a typical polypropylene material.

FIG. 3 schematically illustrates an example of a collapse pressure as a function of temperature.

FIG. 4 schematically shows a side view of an embodiment of a substantially constant low injection-pressure molding apparatus constructed according to the disclosure.

FIG. 4A schematically shows a fragmental view of the apparatus shown in FIG. 4.

FIG. 5 is a pressure-vs-time graph for the substantially constant low pressure, feedback-controlled, injection process and apparatus of the disclosure superimposed over a pressure-vs-time graph for a conventional high variable pressure injection molding machine.

FIG. 6 is another pressure-vs-time graph for the substantially constant low injection pressure process and apparatus of the disclosure superimposed over a pressure-vs-time graph for a conventional high variable pressure injection molding machine, the graphs illustrating the percentage of fill time devoted to certain fill stages.

FIG. 7 is a pressure-vs-time graph in an exemplary toothbrush's head-handle contact region at selected locations using the substantially constant low pressure, feedback-controlled, overmolding technique of the disclosure.

FIG. 8 is a pressure-vs-time graph in an exemplary toothbrush's head-handle contact region at selected locations using conventional injection molding with a 0.8 s injection time at constant rate, followed by a packing step at reduced pressure.

### DETAILED DESCRIPTION

The present disclosure relates to methods for manufacturing overmolded items, for example consumer goods, containers, and the like, and particularly hollow items, as this terms are defined herein. The present disclosure may be used in conjunction with, e.g., one-shot injection-molding processes or multi-shot injection-molding processes and apparatuses, and may also be used with pre-manufactured articles, such as, e.g., plastic packaging, articles, consumer-goods components, and the like. A one-shot injection-molding process may include a single thermoplastic material being injected into a mold cavity, while a multi-shot injection-molding process may include two separate materials, which may be chemically distinct or chemically identical. The materials can be injected into the same mold cavity or two separate mold cavities. Different materials may be injected simultaneously or at different times. In some embodiments, a relatively soft material may be injected first, followed by a second injection of a relatively hard material in a sequential order that is the reverse of a conventional overmolding operation.

The term “hollow” item (or article or component and the like) refers to items having void interior, as well as non-homogeneous items whose interior density is lower than exterior density. In other words, a “hollow item” comprises a relatively hard/dense shell and a relatively soft core whose density is lower than the shell's density. Defined another way, a “hollow item” is an item comprising a first material having a first density and a second material having a second density, wherein the first material at least partially encompasses the second material and wherein the first density is greater than the second density. In some cases the first density may be ten or more times greater than the second density. Non-limiting examples of such materials include hard plastic or thin steel or glass or ceramics at least partially encompassing a foam or wood or cellulose material. Another non-limiting example of a “hollow” item is an item made of a homogeneous material wherein an outer surface of the item has been treated to possess an enhanced hardness/density. The treatment of the outer surface can include, e.g., coating, heat treatment, chemical treatment, UV-treatment, and others known in the art.

The term “collapsible” in conjunction with “item,” “article,” “wall,” and the like, refers to collapsibility of at least one a portion of the outer surface of the item/article/wall, e.g., at least partial violation of the integrity of the item's/article's/wall's structure, which can manifest itself in cracking, denting, and other change of either local or overall geometry of the item or any portion thereof.

The term “low pressure,” as used herein with respect to melt pressure of a thermoplastic material, means melt pressures in a vicinity of a nozzle of an injection-molding machine of about 10,000 pounds per square inch (psi) and lower, such as, for example, about 400 psi. Melt pressure within the cavity, including melt pressure against a location on the cavity wall or including melt pressure against an item being overmolded, may be as low as zero psi, or in another example non-limiting, at atmospheric pressure.

The term “substantially constant pressure” as used herein with respect to a melt pressure of a thermoplastic material, means that deviations from a baseline melt pressure do not produce meaningful changes in physical properties of the thermoplastic material. For example, “substantially constant pressure” includes, but is not limited to, pressure variations for which viscosity of the melted thermoplastic material do not meaningfully change. The term “substantially constant” in this respect includes deviations of approximately +/−30% from a baseline melt pressure. For example, the term “a substantially constant pressure of approximately 32 MPa (about 4,600 psi)” includes pressure fluctuations within the range of about 42 MPa (about 6,000 psi) (30% above 32 MPa (4,600 psi)) to about 22 MPa (about 3,200 psi) (30% below 32 MPa (about 4,600 psi)). A melt pressure is considered substantially constant as long as the melt pressure fluctuates no more than +/−30% from the recited pressure.

The term “melt holder,” as used herein, refers to the portion of an injection molding machine that contains molten plastic in fluid communication with the machine nozzle. The melt holder is heated, such that a polymer may be prepared and held at a desired temperature. The melt holder is connected to a power source, for example a hydraulic cylinder or electric servo motor, that is in communication with a central control unit or controller, and can be controlled to advance a diaphragm to force molten plastic through the machine nozzle. The molten material then flows through the runner system into the mold cavity. The melt holder may be cylindrical in cross section, or have alternative cross sections that will permit a diaphragm to force polymer under pressures that can range from as low as 100 psi to pressures of 40,000 psi or higher through the machine nozzle. The diaphragm may optionally be integrally connected to a reciprocating screw with flights designed to plasticize polymer material prior to injection.

The term “peak flow rate” generally refers to the maximum volumetric flow rate, as measured at the machine nozzle.

The term “peak injection rate” generally refers to the maximum linear speed the injection ram travels in the process of forcing polymer into the feed system. The ram can be a reciprocating screw such as in the case of a single stage injection system, or a hydraulic ram such as in the case of a two stage injection system.

The term “ram rate” generally refers to the linear speed at which the injection ram travels in the process of forcing polymer into the feed system.

The term “flow rate” generally refers to the volumetric flow rate of polymer as measured at the machine nozzle. This flow rate can be calculated based on the ram rate and ram cross sectional area, or measured with a suitable sensor located in the machine nozzle.

The term “cavity percent fill” generally refers to the percentage of the cavity that is filled on a volumetric basis. For example, if a cavity is 95% filled, then the total volume of the mold cavity that is filled is 95% of the total volumetric capacity of the mold cavity.

The term “melt temperature” generally refers to the temperature of the polymer that is maintained in the melt holder and in the material feed system when a hot runner system is used, which keeps the polymer in a molten state. The melt temperature varies by material; however, a desired melt temperature is generally understood to fall within the ranges recommended by the material manufacturer.

The term “intensification ratio” generally refers to the mechanical advantage the injection power source has on the injection ram forcing the molten polymer through the machine nozzle. For hydraulic power sources, it is common that the hydraulic piston will have a 10:1 mechanical advantage over the injection ram. However, the mechanical advantage can range from ratios much lower, such as 2:1, to much higher mechanical advantage ratio such as 50:1.

The term “peak power” generally refers to the maximum power generated when filling a mold cavity. The peak power may occur at any point in the filling cycle. The peak power is determined by the product of the plastic pressure as measured at the machine nozzle multiplied by the flow rate as measured at the machine nozzle. Power is calculated by the formula P=p*Q where p is pressure and Q is volumetric flow rate.

The term “volumetric flow rate” generally refers to the flow rate as measured at the machine nozzle. This flow rate can be calculated based on the ram rate and ram cross sectional area, or measured with a suitable sensor located in the machine nozzle.

The terms “filled” and “full,” when used with respect to a mold cavity including thermoplastic material, are interchangeable and both terms mean that thermoplastic material has stopped flowing into the mold cavity.

The term “shot size” generally refers to the volume of polymer to be injected from the melt holder to completely fill the mold cavity or cavities. The shot size volume is determined based on the temperature and pressure of the polymer in the melt holder just prior to injection. In other words, the shot size is a total volume of molten plastic material that is injected in a stroke of an injection molding ram at a given temperature and pressure. Shot size may include injecting molten plastic material into one or more injection cavities through one or more gates. The shot of molten plastic material may also be prepared and injected by one or more melt holders.

The term “hesitation” generally refers to the point at which the velocity of the flow front is minimized sufficiently to allow a portion of the polymer to drop below its no flow temperature and begin to freeze off.

The term “electric motor” or “electric press,” when used herein includes both electric servo motors and electric linear motors.

The term “Peak Power Flow Factor” refers to a normalized measure of peak power required by an injection molding system during a single injection molding cycle and the Peak Power Flow Factor may be used to directly compare power requirements of different injection molding systems. The Peak Power Flow Factor is calculated by first determining the Peak Power, which corresponds to the maximum product of molding pressure multiplied by flow rate during the filling cycle (as defined herein), and then determining the shot size for the mold cavities to be filled. The Peak Power Flow Factor is then calculated by dividing the Peak Power by the shot size.

The term “substantially constant low injection pressure molding machine” and the like is defined as a class 101, class 401, or a class 30 injection molding machine that uses a substantially constant injection pressure that is less than or equal to about 69 MPa (about 10,000 psi). Alternatively, the term “substantially constant low injection pressure molding machine” may be defined as an injection molding machine that uses a substantially constant injection pressure that is less than or equal to about 42 MPa (about 6,000 psi). In another embodiment, the term “substantially constant low injection pressure molding machine” may be defined as an injection molding machine that uses a substantially constant injection pressure that is less than or equal to about 69 MPa (about 10,000 psi) and that is capable of performing more than about 100,000 cycles, alternatively more than about 1 million cycles, alternately more than about 1.25 million cycles, alternately more than about 2 million cycles, alternately more than about 5 million cycles, alternately more than about 10 million cycles, or alternatively more than about 1 million cycles to less than about 20 million before the mold core (which is made up of first and second mold parts that define a mold cavity therebetween) reaches the end of its useful life. Characteristics of “substantially constant low injection pressure molding machines” may include, for example, mold cavities having an L/T ratio of greater than 100 (as an example, greater than 200), multiple mold cavities (as an example, 4 mold cavities, as another example, 16 mold cavities, as another example, 32 mold cavities, as another example, 64 mold cavities, as yet another example, 128 mold cavities and as still yet another example 256 mold cavities, or any number of mold cavities between 4 and 512, a heated or cold runner, and/or a guided ejection mechanism.

The term “useful life” is defined as the expected life of a mold part before failure or scheduled replacement. When used in conjunction with a mold part or a mold core (or any part of the mold that defines the mold cavity), the term “useful life” means the time a mold part or mold core is expected to be in service before quality problems develop in the molded part, before problems develop with the integrity of the mold part (e.g., galling, deformation of parting line, deformation or excessive wear of shut-off surfaces), or before mechanical failure (e.g., fatigue failure or fatigue cracks) occurs in the mold part. Typically, the mold part has reached the end of its “useful life” when the contact surfaces that define the mold cavity must be discarded or replaced. The mold parts may require repair or refurbishment from time to time over the “useful life” of a mold part and this repair or refurbishment does not require the complete replacement of the mold part to achieve acceptable molded part quality and molding efficiency. Furthermore, it is possible for damage to occur to a mold part that is unrelated to the normal operation of the mold part, such as a part not being properly removed from the mold and the mold being forcibly closed on the non-ejected part, or an operator using the wrong tool to remove a molded part and damaging a mold component. For this reason, spare mold parts are sometimes used to replace these damaged components prior to them reaching the end of their useful life. Replacing mold parts because of damage does not change the expected useful life.

The term “effective cooling surface” is defined as a surface through which heat is removed from a mold part. One example of an effective cooling surface is a surface that defines a channel for cooling fluid from an active cooling system. Another example of an effective cooling surface is an outer surface of a mold part through which heat dissipates to the atmosphere. A mold part may have more than one effective cooling surface and thus may have a unique average thermal conductivity between the mold cavity surface and each effective cooling surface.

The term “nominal wall thickness” is defined as the theoretical thickness of a mold cavity if the mold cavity were made to have a uniform thickness. The nominal wall thickness may be approximated by the average wall thickness. The nominal wall thickness may be calculated by integrating length and width of the mold cavity that is filled by an individual gate.

The term “mold cooling region” is defined as a volume of material that lies between the mold cavity surface and an effective cooling surface.

The term “cycle time” is defined as a single iteration of an injection molding process that is required to fully form an injection molded part. Cycle time includes the stages of advancing molten thermoplastic material into a mold cavity, substantially filling the mold cavity with thermoplastic material, cooling the thermoplastic material, separating first and second mold sides to expose the cooled thermoplastic material, removing the thermoplastic material, and closing the first and second mold sides.

The terms “item,” “article,” “product,” component,” and the like may be used herein synonymously, depending on the context.

The terms “substantially,” “about,” “approximately,” and the like, unless otherwise specified, may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. Unless otherwise defined herein, the terms “substantially,” “about,” and “approximately” mean the quantitative comparison, value, measurement, or other representation may fall within 20% of the stated reference. Further, the dimensions and values disclosed herein are not to be understood as being strictly limited to the exact numerical values recited. Instead, unless otherwise specified, each such dimension is intended to mean both the recited value and a functionally equivalent range surrounding that value. For example, a value disclosed as “30%” is intended to mean “about 30%.” Thus, e.g., the term “substantially constant pressure” of a thermoplastic material means that deviations from a baseline melt pressure do not produce meaningful changes in physical properties (such as, e.g., viscosity) of the thermoplastic material.

The substantially constant low injection pressure, feedback-controlled, overmolding process shown and described herein may comprise a multi-shot process, although such is not required. If multiple shots are used, some or each the shots may encapsulate a discrete pre-manufactured article or the same pre-manufactured article. The materials that may be used to overmold such a pre-manufactured article(s) using a single-shot injection or multiple-shot injection and apparatus may include, but are not be limited to, materials that have properties such as, e.g., thermal conductivity, thermal non-conductivity, or combinations thereof, electrical conductivity, electrical non-conductivity, or combinations thereof, optical transparency, optical translucency, optical opaqueness or combinations thereof; the materials may also be hydrophobic, oleophobic, water resistant, and/or any combinations of all the aforementioned.

The apparatuses and methods disclosed herein include improved injection-molding techniques comprising, in part, substantially constant and low injection pressure to form overmolded articles. The apparatuses and methods disclosed herein may improve overmolded article quality by creating a more consistent and more uniform process that may reduce temperatures and pressures exerted upon pre-manufactured articles during formation and/or injection of the overmolded article, which may affect the types of pre-manufactured articles that may be used during injection molding. Reduced temperatures and pressures during an injection-molding process may increase the types of pre-manufactured articles that can be overmolded. For example, hollow fragile items, having relatively thin walls, may be damaged by traditional injection-molding operations.

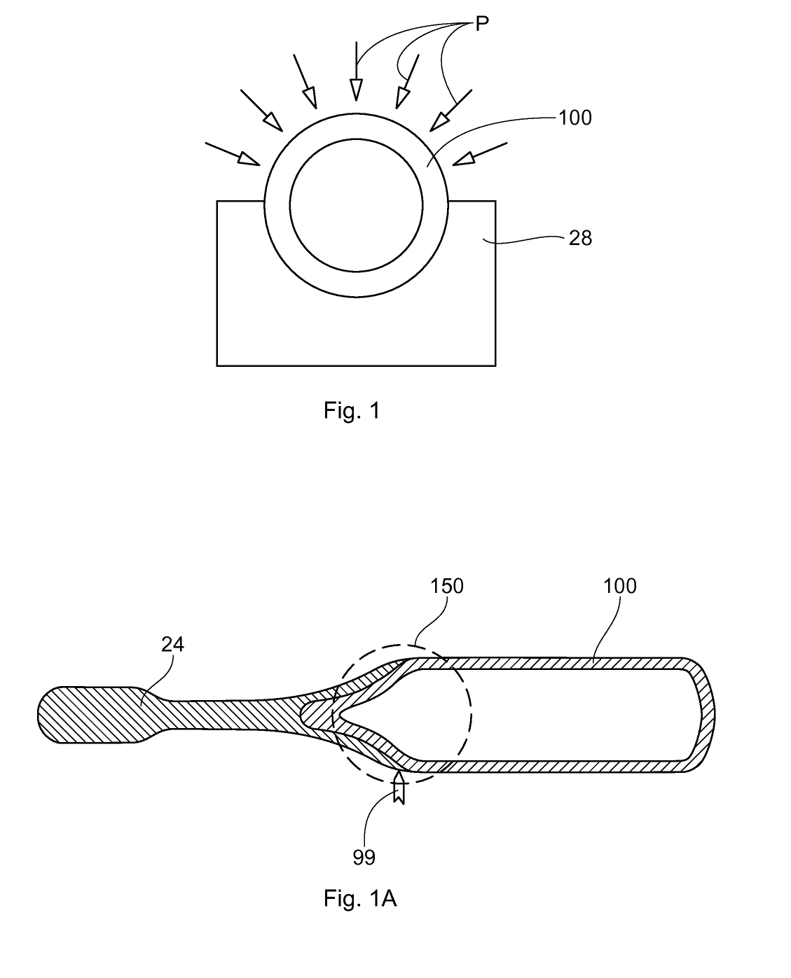

As is schematically shown in FIG. 1, a fragile hollow item 100 can be disposed in a mold cavity of a mold 28 to be supported by one of the mold's portions, by virtue of having the item's outer surface in contact with the mold part's surface so that from about 5% to about 95% of the item's overall walls' surface is exposed to the outside pressure P created by a thermoplastic material used to overmold the item 100. In another embodiment, from about 15% to about 85% of the item's overall walls' surface can exposed to the outside pressure P created by a thermoplastic material. In still another embodiment, from about 25% to about 75% of the item's overall walls' surface is exposed to the outside pressure P created by a thermoplastic material. In yet another embodiment, from about 40% to about 60% of the item's overall walls' surface is exposed to the outside pressure P created by a thermoplastic material. In a further embodiment, about 50% of the item's overall walls' surface can exposed to the outside pressure P created by a thermoplastic material.

In FIG. 1, the walls of the hollow item 100 are not supported from inside of the hollow article 100 by any additional structure, comprising, e.g., mold metal, such as, e.g., a rod or other support structure that is not intended to comprise the final overmolded article. One skilled in the art would appreciate that the item 100 may have various integral interior elements, such as, e.g., ribs, flanges, and the like, that would comprise part the finished overmolded article. One skilled in the art will further understand that although the item 100 shown in FIG. 1 is substantially circular in cross-section, the item 100 can have any cross-section, including, e.g., without limitation, rectangular, triangular, elliptical, polygonal, and other regular and irregular shapes. The article's walls, or portions thereof, not directly supported from the inside of the article can therefore be vulnerable to the outside pressure developed in the mold cavity by the overmolding thermoplastic material.

While analytical solutions to the problem of threshold hydrostatic stress or pressure to buckle thin-wall pressure vessels are available for many shapes of vessel, the overmolding of a thin-wall hollow item can hardly be accurately approximated. The extreme non-linearity of plastic strength with temperature, combined with the non-homogeneous variation of temperature with time in the item being overmolded as the injected hot plastic contacts and surrounds it makes any such approximation by closed-form analytical methods extremely difficult. To this end, a thin-wall hollow plastic item has been simulated in a finite-element model to estimate the strength of the article as a function of temperature.

In this model, a two-dimensional cross section of an 8 mm-diameter, 2 mm-wall hollow article can be presented on approximately half of its outer surface with an increasing pressure (FIG. 1). Both the article material and the overmold material can be modeled as polypropylene plastic, for which a relationship between stress and strain can be approximated. FIG. 1A illustrates a cross-sectional view of an exemplary embodiment of a hollow fragile item comprising a sub-component body of a toothbrush. In this embodiment, the thermoplastic material 24 is being partially molded over a portion of a thin-walled pre-manufactured handle (item 100) of the toothbrush being made. Upon solidification, the thermoplastic material 24 will comprise a toothbrush head. FIG. 1A also shows that the hollow item 100 has an area of particular vulnerability 150, where the pressure exerted by the molten thermoplastic material 24 is believed to be the highest.

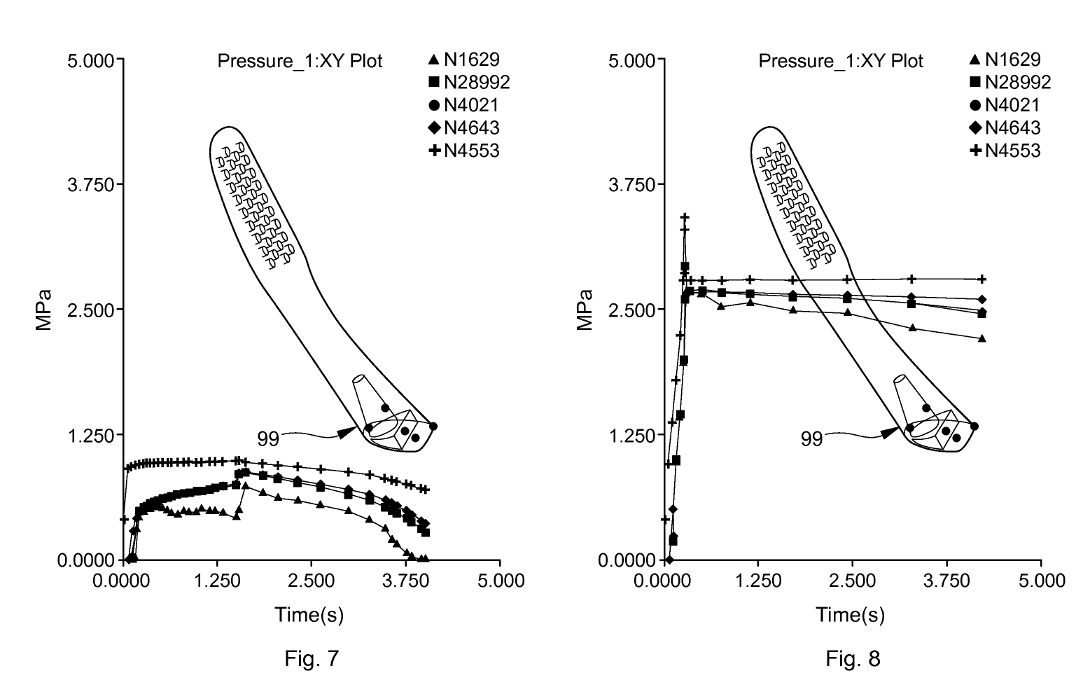

FIGS. 7 and 8 illustrate the advantages of the substantially constant low pressure, feedback-controlled injection technique of the invention. The typical process of injection-molding the type of a toothbrush head shown in FIGS. 7 and 8 would comprise filling, through an injection gate 99, in a first injection step (of approximately 0.5-1.0 seconds) and follow that filling process with a packing step at a pressure slightly reduced from the peak in the first step, FIG. 8. The pressure in the conventional process, illustrated in FIG. 8, far exceeds 1 MPa—and in fact may far exceed 3.5 MPa. The injection gate 99, located near the contact area between the surface of the pre-manufactured hollow handle and the thermoplastic material (best shown in FIG. 1A), provides a supply of a heated thermoplastic material to the handle, which heats adjacent areas disproportionately versus distant areas. A thin-walled hollow plastic handle will therefore be vulnerable to collapse at high pressure, especially when the head-handle contact zone is near the injection gate, where the temperature of the thermoplastic material is very high. In contrast, the substantially constant low pressure, feedback-controlled injection method of the disclosure allows one to overmold the hollow plastic handle at pressures below 1.250 MPa, and specifically at pressures below 1 MPa, FIG. 7.

While the disclosed substantially constant low pressure, feedback-controlled injection method is believed to be particularly beneficial for overmolding the fragile hollow items collapsible under pressures of about 1 MPa and greater, the method may be successfully used for overmolding the fragile hollow items collapsible under pressures of from about 10 MPa to about 25 MPa, from about 5 MPa to about 10 MPa, and from about 1 MPa to about 5 MPa. Respectively, the method includes maintaining the first thermoplastic material in the mold cavity under a substantially constant melt pressure of lower than about 1 MPa (for overmolding the fragile hollow items collapsible under pressures of about 1 MPa and greater), lower than about 10 MPa (for overmolding the fragile hollow items collapsible under pressures of from about 10 MPa to about 25 MPa), and lower than about 5 MPa (for overmolding the fragile hollow item collapsible under a pressure of from about 5 MPa to about 10 MPa).

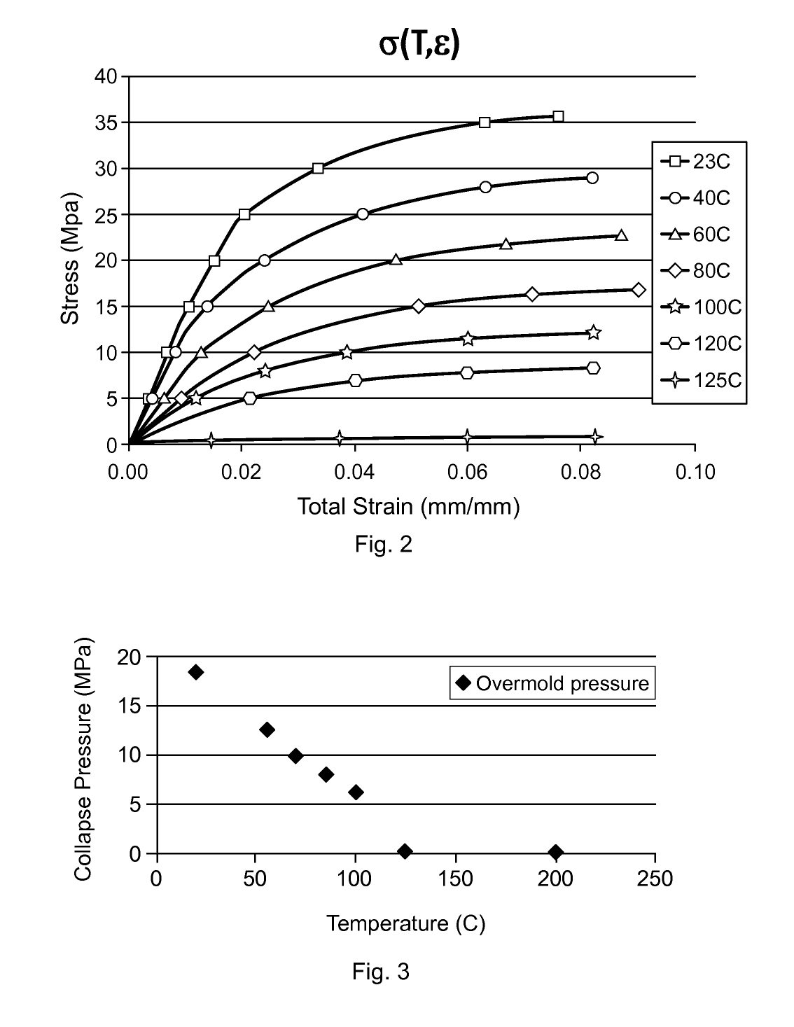

FIG. 2, representing an example of stress-strain curves as a function of temperature for a typical polypropylene, shows this relationship at selected temperatures between the room temperature and the plastic-softening temperature, around 125° C. Above this plastic softening temperature, little or no load may be borne by the hollow item 100. The collapse pressure of the hollow item decreases roughly linearly in proportion to increasing temperature, as is shown in FIG. 3. One skilled in the art should appreciate that the item modeled herein is not meant to describe every hollow, overmoldable item or subassembly, and it may be logically deduced by those skilled in the art that an item with a thinner wall and same mean outer diameter will be less strong and will collapse at proportionate pressures, although the relationship between pressure and temperature is not expected to vary substantially.

Although the hollow item 100 to be overmolded may initially enter the mold cold or at room temperature, re-heating of the hollow item 100 will play a role in the collapse strength of the item 100, as the injected plastic is hot, having a typical temperature of 150-250° C. Therefore, the injected plastic will inevitably transfer, by contact and conduction, heat to the hollow item 100, which will naturally increase the item's temperature. Injection time will also play a role in the strength of the hollow item 100 being overmolded, as a slower injection or a very large overmold shot, containing much thermal mass, may re-heat the hollow item 100 beyond its softening temperature, which would result in the item's almost certain collapse. Alternately, it is known to those skilled in the art that the pressure during injection of plastic increases with speed, though nonlinearly and in a decreasing manner, and thus an overly fast injection speed will exceed the collapse pressure of even a cold overmolded hollow article.

Therefore, there can be an optimum injection time, pressure, and temperature for any given hollow item to be overmolded and plastic that overmolds it. Given the variety of plastics available for injection molding, it may not be possible to list a complete range of suitable pressures, injection temperatures, and injection times for even a single hollow item. But it appears clear that, at least as far as hand-held consumer devices are concerned (typically expected to have room-temperature strength) the 10,000-25,000 psi (68.7-172 MPa), the conventional injection pressures are likely to collapse hollow items having relatively thin walls when these items are being overmolded without precise control of all the relevant parameters, such as pressure, temperature, and time. To this end, it may be desirable to use high-precision feedback pressure control mechanisms to limit the pressure of the overmolding plastic to less than 25 MPa, in some instances to less than 10 MPa, in other instances to less than 5 MPa, in still other instances to less than 2 MPa, and even to less than 1 MPa.

Embodiments of the present disclosure generally relate to systems, machines, products, and methods of producing overmolded articles by overmolding a pre-manufactured article using an injection molding process to form a final overmolded part, and, more specifically, to systems, products, and methods of producing overmolded articles by substantially constant low injection pressure during the injection stage.

The embodiments of the apparatuses and methods described herein may be used to overmold, without limitation, one or more of the following products and/or one or more subcomponents of such products as, e.g., various consumer products, including those directed to baby care, beauty care, fabric care, home care, family care, feminine care, health care, oral care, small appliances, and packaging products.

Such products and components may comprise, e.g., the following items: a 3D-printed article with extra layers of material printed on the outside of the article; an item made of soft wood painted with a hard-lacquer material; an item made of a foam or foamed plastic, such as, e.g., polystyrene foam, subjected to external heat to melt an outer layer, which results in creating a crust or shell on the outside of the item; a foamed plastic item, such as, e.g., foamed ABS, treated on its surface with acetone or another solvent to create a thicker, stronger layer on the outside of the item; an item made of a UV-curable foamed plastic treated with ultraviolet (UV) light to cure and harden the item's outer surface so that the outer surface is harder and stronger than the interior of the item; an item made of an open-cell foam, such as, e.g., a natural or artificial sponge, treated on its surface in any manner described above, to cause the item's outer layer to comprise a substantially contiguously solid or closed-cell material, while retaining the inner-cells structure, wherein the inner cells are still communicating with one another.

After the thermoplastic material is heated, it can be injected, using an injection system or injection element, into one or more mold cavities of the apparatus (e.g., a single mold cavity or a plurality of mold cavities) to overmold a hollow item secured therein. Then, the thermoplastic material can be allowed to substantially freeze or solidify in contact with the surface of the overmolded item, thereby forming an overmolded article. The overmolded item may then be cooled to form a finished article or a component of an article. Alternatively or additionally, the overmolded item can be subjected to a second overmolding or injection process. Overmolded articles produced according to the method and using the apparatus described herein may beneficially have reduced cycle times, reduced defects, and higher yields. Additionally, due to the low injection temperatures, low melt pressures, and low shear pressures, pre-manufactured articles sensitive to temperature, pressure, and shear pressure may be successfully overmolded using the techniques described herein.

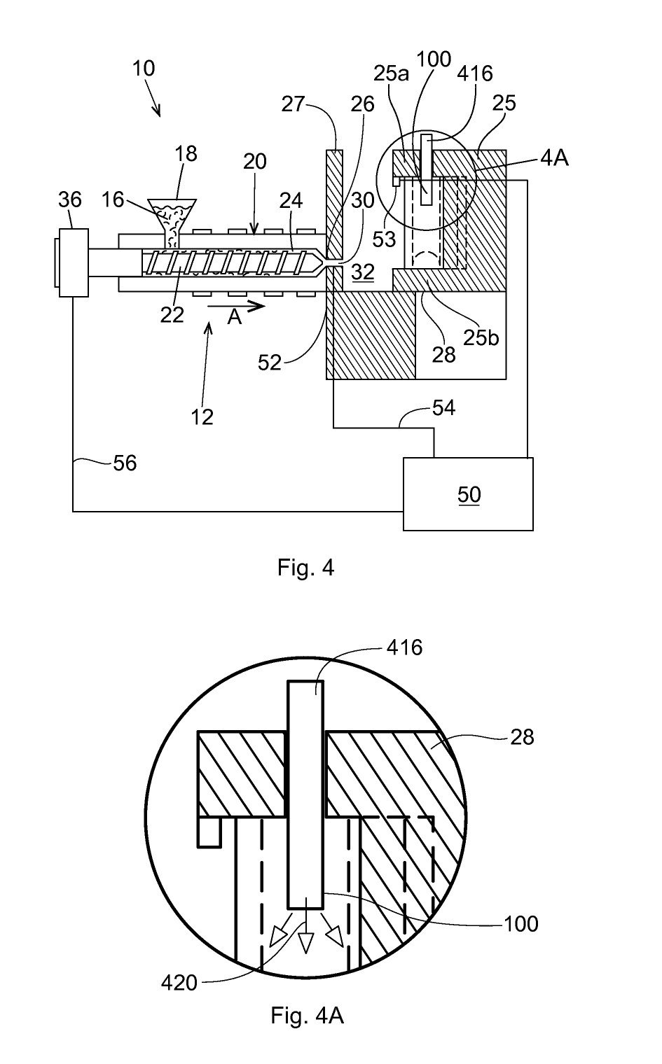

As is schematically shown in FIG. 4, a substantially constant low injection-pressure molding apparatus 10 generally includes a plastic-melt injection system 12, a mold 28, and a clamping system (not shown for convenience). The latter applies, during the molding process, a clamping force that is greater than the force exerted by the injection pressure acting to separate the first and second mold portions 25, 27, thereby holding together the mold portions 25, 27 while a molten thermoplastic material 24 is injected into a mold cavity 32. The apparatus 10 injects the molten thermoplastic material 24 into the mold cavity 32 at a substantially constant melt pressure of at least about 400 psi and at most about 10,000 psi.

The thermoplastic material may be introduced to the plastic melt injection system 12 in the form of pellets 16 that may be placed into a hopper 18, which feeds the pellets 16 into a heated barrel 20 of the injection system 12. The pellets 16, after being fed into the heated barrel 20, may be driven to the end of the barrel 20 by a reciprocating screw 22. The heating of the barrel 20 and the compression of the pellets 16 by the reciprocating screw 22 causes the pellets 16 to melt, forming the molten thermoplastic material 24, which is typically processed at a temperature of about 130 degrees Celsius (° C.) to about 410° C. The injection-molding techniques of the disclosure utilize low injection pressure, and more specifically substantially constant low injection pressure.

The reciprocating screw 22 forces the molten thermoplastic material 24 toward a nozzle 26 to form a shot of thermoplastic material, which will be injected into a mold cavity 32 of the mold 28 via an injection element, such as one or more gates 30 that direct the flow of the material 24 to the mold cavity 32. In other embodiments, the nozzle 26 may be separated from one or more gates 30 by a feed system (not shown). One skilled in the art will appreciate that although a single mold cavity 32 is illustrated in FIG. 4, the apparatus 10 may have multiple mold cavities—which would naturally increase overall production rates. One skilled in the art will further recognize that the shapes of the cavities of each of the plurality of mold cavities may be identical, similar, or different from one another, as well as that the multiple mold cavities may be formed from more than two mold portions.

In the apparatus shown in FIG. 4, the mold cavity 32 is formed between a first mold portion 25 and a second mold portion 27 of the mold 28. The first and second mold portions 25, 27 may be formed from a material having high thermal conductivity, e.g., between about 6 watts per meter Kelvin (about 4 BTUs/(hr-ft-° F.)) and about 385 watts per meter Kelvin (about 223 BTUs/(hr-ft-° F.)), or between about 8 watts per meter Kelvin (about 5 BTUs/(hr-ft-° F.)) and about 385 watts per meter Kelvin (about 223 BTUs/(hr-ft-° F.)), or between about 52 (e.g., 51.9) Watts per meter-Kelvin (about 30 BTUs/(hr-ft-° F.)) and about 385 Watts per meter-Kelvin (about 223 BTUs/(hr-ft-° F.)). In still other examples, one or both of the first and second mold portions 25, 27 may be formed from a material having a thermal conductivity of between about 35 BTUs per (hour-foot-° F.) and about 200 BTUs per (hour-foot-° F.); or between about 40 BTUs per (hour-foot-° F.) and about 190 BTUs per (hour-foot-° F.); or between about 50 BTUs per (hour-foot-° F.) and about 180 BTUs per (hour-foot-° F.); or between about 75 BTUs per (hour-foot-° F.) and about 150 BTUs per (hour-foot-° F.). Several exemplary materials for the mold portions 25, 27 are described in the commonly assigned and copending Provisional Application Ser. No. 61/918,438 (The Procter & Gamble Case Number 13190P), filed on Dec. 19, 2013 in the names of Matthew Lloyd Neman, John Moncrief Layman, Andrew Neltner, Randall Watson, and Gene Michael Altonen, the disclosure of which, as well as the disclosure of the regular application, claiming priority of the above provisional application, and filed on Dec. 19, 2014, are being incorporated herein by reference in their entirety.

The disclosed substantially constant low injection pressure molding method and apparatus operate under molding conditions that permit molds made of softer, higher thermal-conductivity materials to extract useful lives of more than about 100,000 cycles, more than about 200,000 cycles, more than about 500,000 cycles, more than about 700,000 cycles, more than about 1 million cycles, for example between about 100,000 cycles and about 2,000,000 cycles, between about 100,000 cycles and about 1,500,000 cycles, between about 1 million cycles and about 10 million cycles, particularly between about 1.25 million cycles and about 10 million cycles, and more particularly between about 2 million cycles and about 5 million cycles.

The mold 28 may include a cooling circuit (not shown), integrated into or positioned proximate to either or both the first or second mold portions 25, 27, to remove heat from the mold 28, thereby reducing its temperature—and, in some instances, the temperature of the hollow item 100 being overmolded by a thermoplastic material inside the mold cavity 32. The cooling circuit may provide a path for cooling fluid to pass through one or both portions 25, 27 of the mold 28. As the cooling fluid passes through the mold 28, a cooling fluid temperature may be measured, e.g., when the cooling fluid is at its nearest point to the mold cavity 32, as it enters the mold 28, or as it leaves the mold 28.

High thermal conductivity of the mold 28, including the parts 25, 27 thereof, may alleviate the need for dehumidification apparatuses, as differences in temperature between the mold 28 and the ambient environment may be reduced. Further, thermal lag in the mold may be reduced due to the high thermal conductivity of the mold. This may enable the use of, e.g., evaporative cooling fluids and closed circuit systems.

In the embodiment illustrated in FIG. 1, a fragile hollow item 100 is secured in the mold cavity 32. The fragile hollow item 100 may be any pre-manufactured article that is to be partially or completely overmolded by a thermoplastic material. The fragile hollow item 100 may be made of a material selected from plastic, glass, thin-walled metal, foil, ceramic, cardboard, cellulose, carbon-fiber composite, and any combination thereof. The hollow item 100 may comprise a component for a personal-care article, such as selected, e.g., from the group consisting of a toothbrush, a razor, a hairbrush, and a topical applicator. In one specific embodiment the hollow item 100 comprises a body of a toothbrush.

Temperature-sensitive and/or pressure-sensitive items, such as, e.g., those including decorative labels with printed sides, may be used with the apparatuses and methods of overmolding described herein. Items being overmolded may be sensitive to different components of the stress or viscous shear tensor to different degrees. For example, items may be most sensitive to hydrostatic pressure components (diagonal components of the stress or viscous shear tensor) and less sensitive to shear (off-diagonal) components, or vice versa. As one skilled in the art will recognize, hollow articles, which are likely to experience volumetric changes when subjected to hydrostatic pressures, would be more sensitive to diagonal components of the shear tensor.

The fragile hollow item 100 may be secured on one of the mold portions 25, 27. In FIG. 1, the hollow item 100 is shown secured in the first portion 25 of the mold 28, between a top and bottom holding elements 25a, 25b thereof. In other embodiments, the fragile hollow item 100 may be secured using adhesives, clamps, shafts, protrusions, or other securing methods to position the fragile hollow item 100 inside the mold cavity 32. The fragile hollow item 100 may contain adhesive, or adhesive may be applied to a surface of one of the mold portions 25, 27.

The hollow item 100 is secured in the mold 28 such that at least at least 50% of an overall area of the walls of the fragile hollow item is not supported from inside the hollow fragile article. Therefore, during the overmolding process, when the thermoplastic material 24 exerts outside pressure on the walls of the hollow item 100, there is means to resist that pressure other than the structural integrity of the item's walls. Hence, the hollow item 100 is easily collapsible under the influence of the melt pressure created by the thermoplastic material 24 overflowing the walls of the item 100. In one embodiment, the hollow item 100 is collapsible under a pressure greater than about 25 MPa. In another embodiment, the hollow item 100 is collapsible under a pressure of from about 5 MPa to about 10 MPa. Consequently, the apparatus 10 is structured and configured to maintain a substantially constant melt pressure from about 1 MPa to about 25 MPa of the first thermoplastic material 24, thereby preventing the relatively thin walls of the fragile hollow item 100 from collapsing under the melt pressure during overmolding.

The thermoplastic material 24 is heated to a predetermined temperature, which can be lower than the thermoplastic material's lowest injection temperature recommended by the manufacturer. Generally, manufacturers provide a range of melt or injection temperatures for a specific material at which the thermoplastic material is easily injected. But using the apparatus and method described herein, one can heat the thermoplastic material to a lower temperature, e.g., about 100 degrees Celsius lower, about 75 degrees Celsius lower, about 50 degrees Celsius lower, about 40 degrees Celsius lower, or about 25 degrees Celsius lower than the lowest recommended temperature. By another measurement, the predetermined temperature to which the thermoplastic material may be heated may be about 30 degrees Celsius less than a heat-deflection temperature, or plastic-deformation temperature or elastic-deformation temperature of the item 100.

The heated molten thermoplastic material 24 is advanced into the mold cavity 32 until the latter is substantially filled. The molten thermoplastic material 24 may be advanced at a melt temperature measured as the thermoplastic material 24 leaves the injection element and enters the mold cavity 32. The mold cavity 32 is substantially filled when it is more than 90% filled. In another example, the mold cavity 32 is substantially filled when it is more than 95% filled. In still another example, the mold cavity 32 is substantially filled when it is more than 99% filled. Once the shot of molten thermoplastic material 24 is injected into the mold cavity 32, the reciprocating screw 22 stops traveling forward.

A controller 50 is communicatively connected on one hand with a sensor 52, which may be conveniently located in the vicinity of the nozzle 26 and the injection element or gates 30, and on the other hand with a screw control 36. The controller 50 may include a microprocessor, a memory, and one or more communication links. When melt pressure and/or melt temperature of the thermoplastic material is measured by the sensor 52, this sensor 52 sends a signal indicative of the pressure or the temperature to the controller 50 to provide a target pressure for the controller 50 to maintain in the mold cavity 32 (or in the nozzle 26) as the fill is completed. This signal may generally be used to control the molding process, such that variations in material viscosity, mold temperatures, melt temperatures, and other variations influencing filling rate, are adjusted by the controller 50. These adjustments may be made immediately during the molding cycle, or corrections can be made in subsequent cycles. Furthermore, several signals may be averaged over a number of cycles and then used to make adjustments to the molding process by the controller 50. The controller 50 may be connected to the sensor 52 and the screw control 36 via wired connections 54, 56, respectively. In other embodiments, the controller 50 may be connected to the sensor 52 and screw control 36 via a wireless connection, a mechanical connection, a hydraulic connection, a pneumatic connection, or any other type of communication connection known to those having ordinary skill in the art, and that will allow the controller 50 to effectively communicate with both the sensor 52 and the screw control 36 (e.g., including a feedback loop).

In the embodiment of FIG. 4, the sensor 52 is a pressure sensor that measures, directly or indirectly, melt pressure of the molten thermoplastic material 24 in the vicinity of the nozzle 26. The thermoplastic material 24 may be injected at a maximum melt pressure that is within 30% of a minimum melt pressure of the thermoplastic material entering the mold cavity 32, such that the melt pressure is maintained substantially constant. Manufacturers generally provide recommended injection-pressure or melt-pressure ranges, a sample of which is reproduced herein. Using the apparatus and method described herein, the melt pressure of the thermoplastic material 24 entering the mold cavity 32 may be less than the lowest injection pressure recommended by the manufacturer.

The sensor 52 generates an electrical signal that is transmitted to the controller 50. The controller 50, which, in turn, commands the screw control 36 to advance the screw 22 at a rate that maintains a desired melt pressure of the molten thermoplastic material 24 in the nozzle 26. While the sensor 52 may directly measure the melt pressure, the sensor 52 may also indirectly measure the melt pressure by measuring other characteristics of the molten thermoplastic material 24, such as temperature, viscosity, flow rate, etc., which are indicative of melt pressure. Likewise, the sensor 52 need not be located directly in the nozzle 26, but may be located at any place within the plastic melt injection system 12 or mold 28 that is fluidly connected with the nozzle 26. If the sensor 52 is located in a place not within the nozzle 26, appropriate correction factors may be applied to the measured characteristic to calculate an estimate of the melt pressure in the nozzle 26. The sensor 52 need not be in direct contact with the injected material and may alternatively be in dynamic communication with the material and be able to sense the pressure of the material and/or other fluid characteristics thereof. In yet other embodiments, the sensor 52 need not be disposed at a location that is fluidly connected with the nozzle 26. Rather, the sensor 52 could measure clamping force generated by the clamping system at a mold parting line between the first and second mold portions 25, 27. In one aspect, the controller 50 may maintain the pressure according to the input from the sensor 52. Alternatively, the sensor 52 can measure an electrical-power demand by an electric press, which may be used to calculate an estimate of the pressure in the nozzle 26.

Although an active, closed loop controller 50 is illustrated in FIG. 4, other pressure-regulating devices may be used instead or in addition to the controller 50. For example, a pressure-regulating valve (not shown) or a pressure-relief valve (not shown) may be used instead of the controller 50 to regulate the melt pressure of the molten thermoplastic material 24. The pressure-regulating valve and pressure-relief valve can prevent over-pressurization of the mold 28. Another alternative or additional mechanism for preventing over-pressurization of the mold 28 may comprise an alarm that is activated when an over-pressurization condition is detected.

The apparatus 10 may further use a second sensor 53 located near an end of flow position (i.e., near an end of the mold cavity) to monitor changes in material viscosity, changes in material temperature, and changes in other material properties. Measurements from this sensor may be communicated to the controller 50 to allow the controller 50 to correct the process in real time and to ensure that the melt-front pressure is relieved prior to the melt front reaching the end of the mold cavity 32. Otherwise, flashing of the mold 28 or collapse of the hollow item 100 being overmolded may occur.

Also, the controller 50 may use the sensor measurements to adjust the peak power and peak flow rate points in the process, so as to achieve consistent processing conditions. In addition to using the sensor measurements to fine tune the process in real time during the current injection cycle, the controller 50 may also adjust the process over time (e.g., over a plurality of injection cycles). In this way, the current injection cycle can be corrected based on measurements occurring during one or more cycles at an earlier point in time. In one embodiment, sensor readings can be averaged over many cycles so as to achieve process consistency.

Upon injection into the plurality of mold cavities 32, the molten thermoplastic material 24 contacts the interior surface of the mold cavity 32 and the exterior surface of the walls of the hollow item 100—and takes the form of those at the contact surfaces. Thereafter, the molten thermoplastic material solidifies. This may be allowed to occur naturally or passively, through convection and conduction to the atmosphere—or the molten thermoplastic material 24 may be actively cooled with using a cooling system that may include, e.g., a cooling liquid flowing through at least one of the first and second mold portions 25, 27. Once the thermoplastic material 24 has solidified, the clamping system releases the first and second mold portions 25, 27. Once the first and second mold portions 25, 27 are separated from one another, the finished overmolded article, comprising an item 1000 overmolded with the solidified thermoplastic material 24, may be ejected from the mold 28. One skilled in the art will recognize that the article may be ejected or removed by any suitable means known in the art, e.g., ejection, dumping, releasing, removing, extraction (manually or via an automated process, including robotic action), pulling, pushing, gravity, or any other method of separating the cooled overmolded article from the first and second mold portions 25, 27. After the cooled overmolded article is removed from the mold 28, another hollow article can be secured therein, the first and second mold portions 25, 27 may be closed, and cycle repeated. Cycle time can be defined as a single iteration of the molding cycle.

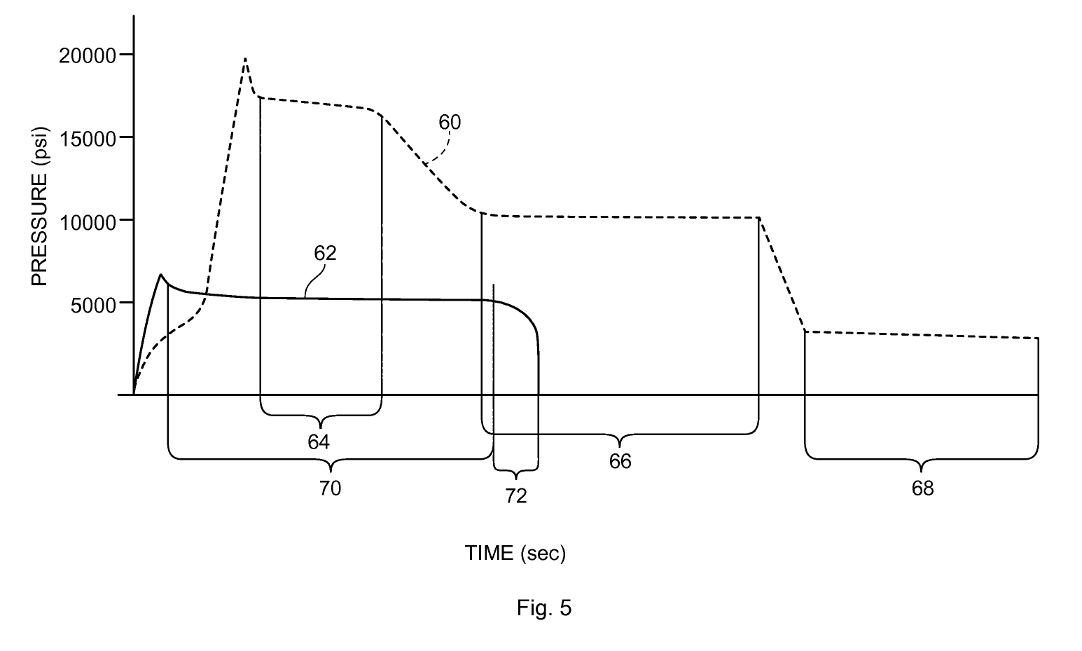

In FIG. 5, the dashed line 60 represents a typical pressure-time curve for a conventional high variable pressure-injection molding process. By contrast, a pressure-time curve for the disclosed substantially constant low injection-pressure molding machine 10 and process is illustrated by the solid line 62. In the conventional case, melt pressure is rapidly increased to well over about 15,000 psi and then held at a relatively high pressure, more than about 15,000 psi, for a first period of time 64. The first period of time 64 is the fill time, in which molten plastic material flows into the mold cavity. Thereafter, the melt pressure is decreased and held at a lower, but still relatively high pressure, typically about 10,000 psi or higher, for a second period of time 66. The second period of time 66 is a packing time in which the melt pressure is maintained to ensure that all gaps in the mold cavity are back filled. After packing is complete, the pressure may optionally be dropped again for a third period of time 68, which is the cooling time. The mold cavity in the conventional high variable pressure injection molding system is packed from the end of the flow channel back to towards the gate. The material in the mold typically freezes off near the end of the cavity, and then the completely frozen-off region of material progressively moves toward the gate location, or locations. As a result, the plastic near the end of the mold cavity is packed for a shorter time period and with reduced pressure than the plastic material that is closer to the gate location, or locations. Part geometry, such as very thin cross sectional areas midway between the gate and end of mold cavity, can also influence the level of packing pressure in regions of the mold cavity. Inconsistent packing pressure may cause inconsistencies in the finished product, including uneven wall thickness, unbalanced stresses, and high levels of crystallinity. Moreover, the conventional packing of plastic in various stages of solidification results in some non-ideal material properties, for example, molded-in stresses, sink, and non-optimal optical properties.

The substantially constant low injection pressure techniques disclosed herein, in contrast, allow one to inject the molten plastic material into the mold cavity at a substantially constant pressure for a fill time period 70. The injection pressure in FIG. 5 is less than about 25 MPa. In another embodiment, the injection pressure may be less than about 10 MPa. Other embodiments may use even lower pressures, such as, e.g., less than about 5 MPa, or less than about 2 MPa, or less than about 1 MPa. After the mold cavity is filled, the substantially constant low injection pressure molding machine 10 gradually reduces pressure over a second time period 72 as the molded part is cooled. By using a substantially constant pressure, one can cause the molten thermoplastic material to maintain a continuous melt-flow front that advances through the flow channel from the gate towards the end of the flow channel. In other words, the molten thermoplastic material remains moving throughout the mold cavity, which prevents premature freeze-off of the material. Thus, the plastic material remains relatively uniform at any point along the flow channel, which results in a more uniform and consistent finished product. By filling the mold with a relatively uniform pressure, one can have the finished molded parts form crystalline structures having better mechanical and optical properties than conventionally molded parts. Moreover, the parts molded at constant pressures exhibit different characteristics than skin layers of conventionally molded parts. As a result, parts molded under constant pressure may have better optical properties than parts of conventionally molded parts.

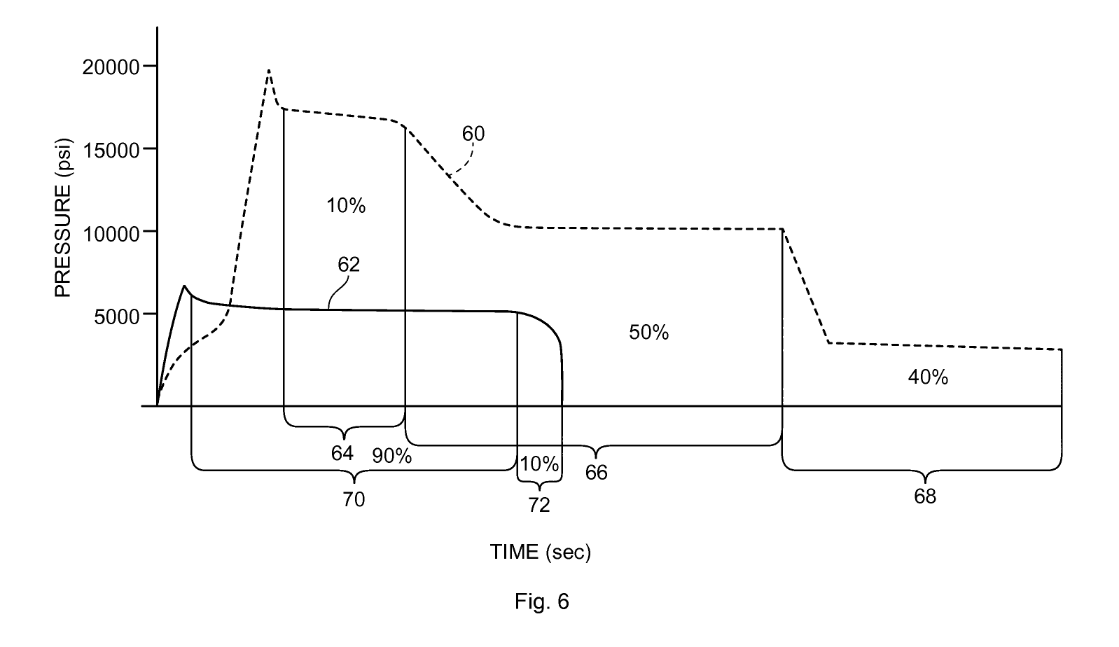

FIG. 6 illustrates various stages of fill, which are broken down as percentages of overall fill time. For example, in a conventional high variable pressure-injection molding process, the fill period 64 comprises about 10% of the total fill time, the packing period 66 comprises about 50% of the total fill time, and the cooing period 68 comprises about 40% of the total fill time. In contrast, in some examples of the substantially constant-pressure injection-molding process described herein, the fill period 70 comprises about 90% of the total fill time while the cooling period 72 comprises only about 10% of the total fill time. In some other examples of the substantially constant-pressure injection-molding process, the cooling period 72 may comprise about 50% of the fill time or about 25% of total fill time. The substantially low constant-pressure injection molding needs less cooling time because the molten plastic material is cooling as it is flowing into the mold cavity. Thus, by the time the mold cavity is filled, the molten plastic material has cooled significantly, although not quite enough to freeze off in the center cross section of the mold cavity, and there is less total heat that needs to be removed to complete the freezing/solidifying process. Additionally, because the molten plastic material remains liquid throughout the fill, and packing pressure is transferred through this molten center cross section, the molten plastic material remains in contact with the mold cavity walls (as opposed to freezing off and shrinking away). As a result, the substantially constant-pressure injection-molding techniques described herein are capable of filling and cooling a molded part in less total time than in a conventional high variable pressure-injection molding process.

Peak power and peak flow rate vs. percentage of mold cavity fill are illustrated in FIG. 6 for both conventional high variable pressure processes 60 and for substantially constant pressure processes 62. In the substantially constant-pressure process 62, the peak power load occurs at a time approximately equal to the time the peak flow rate occurs, and then declines steadily through the filling cycle. More specifically, the peak power and the peak flow rate occur in the first 30% of fill, and in another example, in the first 20% of fill, and in yet another example, in the first 10% of fill. By arranging the peak power and peak flow rate to occur during the beginning of fill, one does not subject the thermoplastic material to the extreme conditions when it is closer to freezing. It is believed that this results in superior physical properties of the molded parts.

The power level generally declines slowly through the filling cycle following the peak power load. Additionally, the flow rate generally declines slowly through the filling cycle following the peak flow rate because the fill pressure is maintained substantially constant. As illustrated above, the peak power level is lower than the peak power level for a conventional process, generally from about 30 to about 50% lower and the peak flow rate is lower than the peak flow rate for a conventional process, generally from about 30 to about 50% lower.

Similarly, the peak power load for a conventional high variable pressure process occurs at a time approximately equal to the time the peak flow rate occurs. However, unlike the substantially constant process, the peak power and flow rate for the conventional high variable pressure process occur in the final 10%-30% of fill, which subjects the thermoplastic material to extreme conditions as it is in the process of freezing. Also unlike the substantially constant pressure process, the power level in the conventional high variable pressure process generally declines rapidly through the filling cycle following the peak power load. Similarly, the flow rate in a conventional high variable pressure process generally declines rapidly through the filling cycle following the peak flow rate.

Alternatively, the peak power may be adjusted to maintain a substantially constant injection pressure. More specifically, the filling pressure profile may be adjusted to cause the peak power to occur in the first 30% of the cavity fill, in another example, in the first 20% of the cavity fill, and in yet another example, in the first 10% of the cavity fill. Adjusting the process to cause the peak power to occur within the specific ranges, and then to have a decreasing power throughout the remainder of the cavity fill results in the same benefits for the molded part that were described above with respect to adjusting peak flow rate.

The process may comprise gas-assisted injection molding or extrusion-blow molding. As is shown in FIGS. 4 and 4A, a fluid-injecting device 416 may be inserted into the hollow item 100 to inject fluid, such as, e.g., nitrogen, air, argon, thereto, thereby increasing the structural rigidity and wall strength of the item 100. The fluid-injecting device 416 may be structured and configured to inject fluid so that the fluid flows substantially omnidirectionally from the fluid injecting-device 416, as indicated by arrows 420 in Gig. 4A, thereby increasing the internal pressure on the walls of the item 100. In this manner, the wall strength of the hollow item 100 may be increased by about 15%-30% in some instances. Inflating the fragile hollow item 100 by injecting an injection fluid into its body may be particularly beneficial if this results in substantially equalizing the internal pressure and the melt pressure created by the thermoplastic material.

In a further embodiment, the method may comprise a second (and third, fourth, and so on, as desired) overmolding step (or steps), so that the hollow item 100 has several overmolding layers of either identical or different thermoplastic materials. Thus, the method may further comprise the steps of providing a second thermoplastic material; heating the second thermoplastic material to a second predetermined temperature thereby causing the second thermoplastic material to be in a flowable state; at least partially overmolding the first overmolded article with the second thermoplastic material in a second mold; and causing the second thermoplastic material to solidify over and in contact with at least one of the solidified first thermoplastic material and the walls of the fragile hollow item. These steps of the process, involving the second thermoplastic material, may occur on the same or similar molding machine, schematically shown in FIG. 4. Because these steps are similar to those described herein with respect to the first thermoplastic material, and can therefore be easily visualized and understood by one skilled in the art, these steps are not separately illustrated herein. If injected into the same mold 28, the second thermoplastic material may be injected through the same (or different) gate or gates into an unfilled portion of the mold cavity 32. Alternatively, the second material may be injected in a second mold's cavity after the item 100, overmolded with the first thermoplastic material, has been secured in the second mold. The second thermoplastic material may have a chemical affinity for the first thermoplastic material, in which instance the two thermoplastic materials will form a chemical bond therebetween. Alternatively or additionally, the molding processes and equipment may be configured to cause the two thermoplastic materials to form one or more mechanical interlocking elements structured to secure the first and second thermoplastic elements together.

Use of the substantially constant injection pressure molding machines and methods described herein can offer a substantial improvement for overmolding processes of hollow fragile items, and can provide many of the advantages of the conventional process of molding a TPE over PP, by reversing the order of the process. First, the lowering of the injection pressure of a second component, or harder material, will reduce the likelihood of gross deformation of the first, softer component at any points of contact between the first and second materials. The use of high-speed feedback and control of the injection pressure can allow substantial reductions in injection pressure of relatively hard thermoplastics. Second, the lower injection pressure corresponds to a slower injection rate. For example, instead of injecting at about 100 mm/s, it may be possible to inject at about 10 mm/s or in another example, about 5 mm/s, with less risk of gate freeze. At these lower injection pressures, there is less shear in the plastic, and thus less shear of the plastic against any cavity wall to which it comes in intimate contact. The injected thermoplastic will transfer a lower magnitude of shear force to the wall of the cavity comprising the thermoplastic elastomer, and will thus tend to deform it less by nature of shear than would thermoplastic injected in a conventional overmolding process.

As the injection speed decreases for a given part, the injection time must increase substantially in proportion, as the difference in part density for a slowly-injected part is substantially the same for a conventionally-injected part. Not to be limited by theory, this increase in injection time during injection of the harder thermoplastic material may lead to undesired re-melting of the thermoplastic elastomer near the injection gate. For this reason, an again not to be limited by theory, in some embodiments the harder thermoplastic may be injected at some injection pressure that is greater than the minimum possible pressure to inject and still maintain suitable finished part quality. In this case, a lower bound on injection pressure may be dictated by part geometry and thermoplastic-elastomer material properties.

The substantially constant injection-pressure molding apparatus and method described herein allow for improved balanced heat removal from internal and external surfaces of the item being overmolded. The overmolded articles produced using the low-pressure overmolding techniques described herein may further allow for improved cooling, due to the reduced thermal gradient between the thermoplastic material and the mold itself. The thermal conductivity of the injection mold allows for the thermoplastic material to be cooled more quickly, allowing for faster cycle time and may result in higher quality overmolded articles. Additionally, because of the thermal conductivity of the mold, any cooling circuit or cooling fluid may be maintained at a higher temperature, reducing the load on any chillers required for temperature maintenance, thereby reducing manufacturing costs.

Increased mold temperature, and therefore a reduced temperature gradient between the mold temperature and the molten thermoplastic material also may result in reduced and more uniform stresses contained within the item being overmolded. The temperature gradient between the center of the item and the walls of the item may also be reduced. Additionally, improved cooling of the item being overmolded may result in more uniform internal and external stresses contained in the overmolded item, as well as reduced and more uniform crystallinity. Further, the substantially constant low injection-pressure process used to create overmolded articles may improve consistency of the overmolded articles across a family of molds.

The overmolding techniques described herein may further allow for consistently packing the mold so that at the end of fill region the injection pressure is similar to the injection pressure at the front of fill region. This may result in a reduced risk of overpacking the mold and reduced molded-in stresses in the overmolded article. Additionally, part weight may be decreased, which may reduce costs associated with creating the overmolded item.

A vast variety of thermoplastic materials may be useful for the purposes of the overmolding techniques disclosed herein. Such thermoplastic materials may include normally solid polymers and resins. These materials are described in the commonly assigned and copending applications identified herein above. The same application provides a non-limiting list of several exemplary thermoplastic resins, together with their injection-pressure ranges recommended by their manufacturers.

As described herein, embodiments of the disclosed substantially constant low injection-pressure overmolding techniques can achieve several advantages over conventional high variable pressure injection molding processes, such as, e.g., a more cost effective and efficient process that eliminates the need to balance the pre-injection pressures of the mold cavity and the thermoplastic materials, a process that allows for use of atmospheric mold cavity pressures and, thus, simplified mold structures that eliminate the necessity of pressurizing means, the ability to use lower hardness, high thermal conductivity mold cavity materials that are more cost effective and easier to machine, a more robust processing method that is less sensitive to variations in the temperature, viscosity, and other material properties of the thermoplastic material, and the ability to produce quality injection molded parts at substantially constant pressures without premature hardening of the thermoplastic material in the mold cavity and without the need to heat or maintain constant temperatures in the mold cavity. The disclosed low-pressure overmolding techniques also advantageously reduce total cycle time for the molding process while increasing part quality. Moreover, the disclosed techniques may employ, in some embodiments, electric presses, which are generally more energy efficient and require less maintenance than hydraulic presses. The low injection pressure molding machines and allow molds made of softer materials to extract 1 million or more molding cycles, which would not be possible in conventional high variable pressure injection molding machines as these materials would fail before 1 million molding cycles in a high pressure injection molding machine.

It should now be apparent that the various embodiments of the products comprising hollow components may be produced by a low, substantially constant-pressure overmolding process. While particular reference has been made herein to products for containing consumer goods or consumer goods products themselves, it should be apparent that the overmolding method discussed herein may be suitable for use in conjunction with products for use in the consumer goods industry, the food service industry, the transportation industry, the medical industry, the toy industry, and the like. Moreover, one skilled in the art will recognize the teachings disclosed herein may be used in other industrial areas where overmolding of hollow items or components may be required.

The disclosure of every document cited herein, including any cross-referenced or related patent or application and any patent application or patent to which this application claims priority or benefit thereof, is hereby incorporated herein by reference in its entirety unless expressly excluded or otherwise limited; but the citation of any document is not to be construed as an admission that it is prior art with respect to the present disclosure. To the extent that any meaning or definition of a term in this written document conflicts with any meaning or definition of the term in a document incorporated by reference, the meaning or definition assigned to the term in this written document shall govern.

The steps of the disclosed processes can be performed in an order different from the sequence in which the steps appear in the text herein. While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

We claim:

1. A method of overmolding a fragile hollow item with a plastic material, the method comprising:
providing the fragile hollow item comprising relatively thin walls and collapsible under a pressure of about 25 MPa and greater;
placing the follow fragile item in a first mold, wherein from 5% to 95% of an overall area of the walls of the fragile hollow item is not supported from inside the hollow fragile article;
providing a first thermoplastic material;
heating the first thermoplastic material to a first predetermined temperature thereby causing the first thermoplastic material to be in a flowable state;
at least partially overmolding the fragile hollow item with the first thermoplastic material in the first mold while maintaining a substantially constant melt pressure of the first thermoplastic material of less than about 25 MPa, thereby preventing the relatively thin walls of the fragile hollow item from collapsing under the melt pressure; and
causing the first thermoplastic material to solidify over and in contact with the walls of the fragile hollow item, thereby forming a first overmolded article.

2. The process of claim 1, comprising providing the fragile hollow item collapsible under a pressure of from about 10 MPa to about 25 MPa, and maintaining a substantially constant melt pressure of the first thermoplastic material lower than about 10 MPa.

3. The process of claim 1, comprising providing the fragile hollow item collapsible under a pressure of from about 5 MPa to about 10 MPa, and maintaining a substantially constant melt pressure of the first thermoplastic material lower than about 5 MPa.

4. The process of claim 1, comprising providing the fragile hollow item collapsible under a pressure of from about 1 MPa to about 5 MPa, and maintaining a substantially constant melt pressure of the first thermoplastic material lower than about 1 MPa.

5. The method of claim 1, wherein maintaining a substantially constant melt pressure of the first thermoplastic material comprises repeatedly determining the melt pressure of the first thermoplastic material at an injection nozzle upstream of the mold cavity using at least one sensor in operative communication with at least one controller, wherein the at least one sensor repeatedly sends a signal to the at least one controller, the signal indicating the melt pressure of the first thermoplastic material in the mold.

6. The method of claim 1, wherein the first thermoplastic material has a melt-flow index of from about 0.1 g/10 min to about 500 g/10 min.

7. The method of claim 7, wherein the first thermoplastic material has a melt-flow index of from about 1 g/10 min to about 100 g/10 min.

8. The method of claim 1, further comprising reducing the temperature of the first thermoplastic material to cause the first thermoplastic material to substantially solidify.

9. The method of claim 1, wherein a maximum melt pressure of the first thermoplastic material inside the first mold is within about 30% of a minimum melt pressure of the first thermoplastic material inside the first mold.

10. The method of claim 1, wherein the predetermined first temperature of the first thermoplastic material is at least about 30 degrees Celsius lower than a heat-deflection temperature of the fragile hollow item.

11. The method of claim 1, wherein the fragile hollow item comprises a temperature-sensitive component, such that the fragile hollow item experiences plastic or elastic deformation at the hollow item's deformation temperature and wherein the first predetermined temperature is lower than the hollow item's deformation temperature.

12. The method of claim 1, wherein the fragile hollow item comprises a shear-pressure-sensitive component, such that the fragile hollow item experiences deformation at an upper shear-pressure limit and wherein the first thermoplastic material is injected in the mold at a melt pressure that produces, inside the first mold between the first thermoplastic material and the fragile hollow item, a shear pressure that is lower than the upper shear pressure limit.

13. The method of claim 1, wherein the fragile hollow item comprises an injection-pressure-sensitive component, such that the fragile hollow item experiences deformation at maximum injection pressure and wherein the melt pressure of the first thermoplastic material entering the first mold is lower than the maximum injection pressure.

14. The method of claim 1, further comprising:
providing a second thermoplastic material;
heating the second thermoplastic material to a second predetermined temperature thereby causing the second thermoplastic material to be in a flowable state;
at least partially overmolding the first overmolded article with the second thermoplastic material in a second mold; and
causing the second thermoplastic material to solidify over and in contact with at least one of the solidified first thermoplastic material and the walls of the fragile hollow item.

15. The method of claim 1, wherein the fragile hollow item comprises a component for a personal-care article selected from the group consisting of a toothbrush, a razor, a hairbrush, and a topical applicator.

16. The method of claim 1, wherein the fragile hollow item comprises a material selected from plastic, glass, thin-walled metal, foil, ceramic, cardboard, cellulose, carbon-fiber composite, and any combination thereof.

17. The method of claim 1, further comprising inflating the fragile hollow item by injecting an injection fluid into a body of the fragile hollow item to increase an internal pressure on walls of the fragile hollow item from inside the hollow fragile article.

18. The method of claim 17, wherein inflating the fragile hollow item by injecting an injection fluid into a body of the fragile hollow item results in substantially equalizing the internal pressure and the melt pressure created by the first thermoplastic material.

19. An apparatus for overmolding a fragile hollow item with a plastic material, the apparatus comprising:
at least a first mold part and a second mold part, the first and second mold parts forming therebetween a first mold cavity structured and configured to receive the fragile hollow item therein so that there is a space in the mold cavity between the fragile hollow item and the at least one of the first and second mold parts, the first mold cavity having a volume, a front end, and a rear end opposite to the front end, wherein the hollow item comprises relatively thin walls collapsible under a pressure of about 25 MPa and greater and wherein from 5% to 95% of an overall area of the walls of the fragile hollow item is not supported from inside the hollow item;
an injection device comprising at least a first injection nozzle for injecting a molten first thermoplastic material into the first mold cavity and over the fragile hollow item; and
a pressure-control mechanism for monitoring a melt pressure of the first thermoplastic material and adjusting an injection pressure imparted by the injection device on the first thermoplastic material according to a pressure-dominated algorithm based on the melt pressure of the first thermoplastic material, wherein the pressure-control mechanism comprises at least a first high-frequency pressure sensor located upstream the front end of the first mold cavity.

20. The apparatus of claim 19, wherein the pressure-control mechanism comprises:
at least a second high-frequency pressure sensor located at a last location to fill of the first mold cavity;
a controller in operative communication with the at least first high-frequency pressure sensor and the second high-frequency pressure sensor for computing a required injection pressure; and
an injection-control unit in operative communication with the controller for providing the required pressure while injecting the first thermoplastic material into the first mold cavity.

21. The apparatus of claim 20, wherein each of the at least a first high-frequency pressure sensor and a second high-frequency pressure sensor comprises a piezoelectric transducer structured to detect from 100 melt-pressure measurements per second to 500 melt-pressure measurements per second.
